(19) United States
(12) Patent Application Publication
(10) Pub. No.: US 2012/0257689 A1
(43) Pub. Date: Oct. 11, 2012

(54) METHOD AND APPARATUS FOR CONFIGURING A CHANNEL USING DIVERSITY

(75) Inventors: Sungkwon Hong, Seoul (KR); Kyoungmin Park, Goyang-si (KR); Sungjin Suh, Seoul (KR)

(73) Assignee: Pantech Co. Ltd, Seoul (KR)

(21) Appl. No.: 13/515,626

(22) PCT Filed: Dec. 3, 2010
(86) PCT No.: PCT/KR2010/008608

§ 371 Date: Jun. 13, 2012

(30) Foreign Application Priority Data
Dec. 14, 2009 (KR) 1020090124245

(51) Int. Cl. H04B 7/06; H04B 7/08

(52) U.S. Cl. 375/295; 375/316

(57) ABSTRACT

The present invention discloses a method and an apparatus for configuring a channel using diversity. The method for configuring a channel using uplink diversity according to one embodiment of the present invention comprises the following steps: converting k-bit of information to be transmitted into n-bit, which is an encoded bit, so as to transmit predetermined information from the channel; selecting m-bit from among said n-bit and permitting T-number of transmitting antennas to generate T-number of modulation symbols so as to transmit said m-bit; and transmitting said T-number of modulation symbols as channel symbols from said T-number of transmitting antennas. In the step of generating the modulation symbols, the T-number of transmitting antennas generate the T-number of modulation symbols using R-number of different resources from each other.

### CROSS-REFERENCE TO RELATED APPLICATIONS

This application is the National Stage Entry of International Application PCT/KR2010/008608, filed on Dec. 3, 2010, and claims priority from and the benefit of Korean Patent Application No. 10-2009-0124245 filed on Dec. 14, 2009, both of which are incorporated herein by reference for all purposes as if fully set forth herein.

### BACKGROUND

1. Field

The present invention relates to a method and an apparatus for configuring a channel by using diversity.

2. Discussion of the Background

A 3GPP LTE uplink control channel refers to a channel through which a UE (User Equipment) transmits information required for efficient communication to an eNB (e-Node B), and is defined as a PUCCH (Physical Uplink Control Channel).

In 3GPP LTE-A, it is considered to introduce new technologies such as multiple-user MIMO (Multiple input Multiple Output), CoMP (Coordinated Multi-Point) communication, CA (Carrier Aggregation) and the like, and thus it is required to improve the capability of the uplink PUCCH according to the introduction of the new technologies.

### SUMMARY

The present invention intends to provide a method and an apparatus for configuring a channel by using uplink diversity. More specifically, the present invention intends to provide the capability improvement of an uplink in 3GPP LTE-A.

In accordance with an aspect of the present invention to solve the above-mentioned problem, there is provided a method of configuring a channel by using diversity, the method including converting k bits of information desired to be transmitted through a channel to n bits corresponding to code bits; selecting m bits from the n bits and generating T modulation symbols by T transmission antennas to transmit the m bits; and transmitting the T modulation symbols to a channel symbol by the T transmission antennas, wherein in generating of the T modulation symbols, the T transmission antennas generate the T modulation symbols by using R different resources.

In accordance with another aspect of the present invention, there is provided a method of configuring a channel by using diversity, the method including converting k bits of information to be transmitted through a channel to n bits corresponding to code bits; selecting m bits from the n bits, and generating a first modulation symbol to transmit the m bits by selecting one of a first resource and a second resource which are different from each other; generating a second modulation symbol by using a resource which has not been selected in generating of the first modulation symbol; and transmitting the first modulation symbol through a first transmission antenna, and transmitting the second modulation symbol through a second transmission antenna, wherein the m bit can be indicated by the modulation symbols generated by two transmission antennas and mapping information on the resources used for generating the modulation symbols by the two antennas.

In accordance with another aspect of the present invention, there is provided an apparatus for configuring a channel by using diversity, the apparatus including a channel encoder for converting k bits of information to be transmitted through a channel to n bits corresponding to code bits; a modulation symbol mapper for selecting m bits from the n bits and generating T modulation symbols in T transmission antennas to transmit the m bits; and a transmitter for transmitting the T modulation symbols as channel symbols from the T transmission antennas, wherein the modulation symbol mapper generates the T modulation symbols by using R different resource in the T transmission antennas.

In accordance with another aspect of the present invention, there is provided an apparatus for configuring a channel by using diversity, the apparatus including a channel encoder for converting k bits of information to be transmitted through a channel to n bits corresponding to code bits; a modulation symbol mapper for selecting m bits from the n bits, generating a first modulation symbol by selecting one of a first resource and a second resource which are different, and generating a second modulation symbol by using a resource which has not been selected in generating the first modulation symbol in order to transmit the m bits; and a transmitter for transmitting the first modulation symbol through a first transmission antenna and transmitting the second symbol through a second transmission antenna, wherein the m bits are expressed by the modulation symbols generated in the two transmission antennas and mapping information of resources used for generating the modulation symbols in the two antennas.

In accordance with another aspect of the present invention, there is provided a method of configuring a channel by using diversity, the method including converting k bits of information to be transmitted through a channel to n bits corresponding to code bits and selecting m bits from the n bits; generating T modulation symbols to be transmitted with second energy smaller than first energy consumed for completely transmitting the m bits; and transmitting the T modulation symbols with the second energy by using T transmission antennas, wherein, in generating of the T modulation symbols, the T transmission antennas generate the T modulation symbols by using R different resources.

In accordance with another aspect of the present invention, there is provided a method of receiving information by using diversity, the method including receiving T modulation symbols transmitted with second energy by T transmission antennas of a base station; demodulating the received modulation symbols to generate information of m bits; and decoding n bits including the m bits to generate information of k bits, wherein the second energy is smaller than first energy consumed for completely transmitting the m bits.

In accordance with another aspect of the present invention, there is provided an apparatus for configuring a channel by using diversity, the apparatus including a channel encoder for converting k bits of information to be transmitted through a channel to n bits corresponding to code bits; a modulation symbol mapper for selecting m bits from the n bits, and generating T modulation symbols to be transmitted with second energy smaller than first energy consumed for completely transmitting the m bits; and a transmitter for transmitting the T modulation symbols with the second energy by using T transmission antennas, wherein the modulation symbol mapper generates the T modulation symbols by using R different resources in the T transmission antennas.

In accordance with another aspect of the present invention, there is provided an apparatus for receiving information by using diversity, the apparatus including a receiver for receiving T modulation symbols transmitted with second energy in T transmission antennas of a base station; a demodulator for demodulating the received modulation symbols to generate information of m bits; and a decoder for decoding n bits including the m bits to generate information of k bits, wherein the second energy is smaller than first energy consumed for completely transmitting the m bits.

According to the present invention, multiple antennas modulate signals by using different resources to generate symbols, and a reception side can use matching information between resources and antennas so that it is possible to maximally use a signal space.

Further, it is possible to improve the capability of an uplink in 3GPP LTE-A.

### BRIEF DESCRIPTION OF THE DRAWINGS

FIG. 1 illustrates a process of generating a signal as shown in Table 1.

FIG. 2 illustrates a configuration of a signal using two antennas according to an embodiment of the present invention.

FIG. 3 illustrates a process of allocating a signal according to an embodiment of the present invention.

FIG. 4 illustrates a modulation scheme according to an embodiment of the present invention.

FIG. 5 illustrates a process of generating a modulation symbol according to an embodiment of the present invention.

FIG. 6 illustrates an example showing a configuration of a signal transmitted when m is 3, two antennas are used, and each of the antennas uses a BPSK modulation scheme according to an embodiment of the present invention.

FIG. 7 illustrates a signal configuration scheme according to another embodiment of the present invention.

FIG. 8 illustrates a signal configuration scheme according to yet another embodiment of the present invention.

FIG. 9 illustrates a signal configuration scheme according to still another embodiment of the present invention.

FIG. 10 illustrates a configuration of a signal when there are three antennas according to an embodiment of the present invention.

FIG. 11 illustrates a configuration in which there are three antennas and a modulation symbol is generated such that matching between resources and the antenna is selected through a bit in a particular position according to an embodiment of the present invention.

FIG. 12 illustrates a configuration of a signal when there are three antennas according to an embodiment of the present invention.

FIG. 13 illustrates an example in which multiple antennas overlappingly transmit signals according to an embodiment of the present invention.

FIG. 14 illustrates an example in which a signal is configured such that multiple antennas can overlappingly transmit symbols according to an embodiment of the present invention.

FIG. 15 illustrates a process of configuring a control channel by using uplink diversity according to an embodiment of the present invention.

FIG. 16 illustrates a process of configuring a control channel by using uplink diversity according to another embodiment of the present invention.

### DETAILED DESCRIPTION OF THE ILLUSTRATED EMBODIMENTS

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

In addition, terms, such as first, second, A, B, (a), (b) or the like may be used herein when describing components of the present invention. Each of these terminologies is not used to define an essence, order or sequence of a corresponding component but used merely to distinguish the corresponding component from other component(s). It should be noted that if it is described in the specification that one component is “connected,” “coupled” or “joined” to another component, a third component may be “connected,” “coupled,” and “joined” between the first and second components, although the first component may be directly connected, coupled or joined to the second component.

Further, the present invention is described based on a wireless communication network. An operation performed in the wireless communication network is implemented during a process in which a system (e.g. a base station) managing the corresponding wireless communication network controls the network and transmits data or the operation may be implemented by a terminal coupled to the corresponding wireless communication network.

Information transmitted through a PUCCH which is an LTE uplink control channel includes ACK/NAK information indicating whether a decoding is succeeded in connection with HARQ, CQI/PMI/RI information indicating information on a downlink channel state and the like. CQI (Channel Quality indicator), PMI (Precoding Matrix Indication), and RI (Rank Indicator) are all examples of information related to a channel or data transmission, and such information can be periodically transmitted to an eNB by a UE.

The PUCCH can be divided into two types according to an amount of transmitted information. For example, the two types include a 1/1a/1b type and a 2/2a/2b type. The 1/1a/1b type transmits information having a length of 1 to 2 bits, and transmits SR (Scheduling Request) related information or ACK/NAK information. The 2/2a/2b type transmits information having a maximum length of 13 bits, and transmits information CQI/PMI/RI information and ACK/NAK information.

When diversity by multiple transmission antennas is provided to improve and expand the capability of the PUCCH, it is possible to increase the data accuracy and the data transmission efficiency during a process of transmitting the control information. To this end, an SORM (Spatial Orthogonal Resource Multiplexing) scheme can be used in connection with the PUCCH 2/2a/2b type.

The SORM scheme configures resources and antennas in a two-dimensional form as shown in Table 1 and transmits signals, but does not consider simultaneous transmission from two antennas. A reason why the SORM scheme does not consider the simultaneous transmission is that PAPR (Peak to Average Power Ratio) becomes a larger value in comparison with a conventional LTE Rel. 8 PUCCH PAPR when the antennas transmit signals at the same. Table 1 shows an embodiment in which j=0, 1, . . . , [I/2] and signals of odd and even numbers are alternately transmitted to resources. Accordingly, when a signal configuration is two-dimensionally made in a resource and an antenna level, the SORM scheme is implemented such that two antennas do not simultaneously transmit symbols, which causes a problem of being unable to use a sufficient signal space.

TABLE 1

| | First antenna | Second antenna |
|---|---|---|
| | (physical or logical) | (physical or logical) |
| Resource #x | S_{2·j+1} | 0 |
| Resource #y | 0 | S_{2·j+2} |

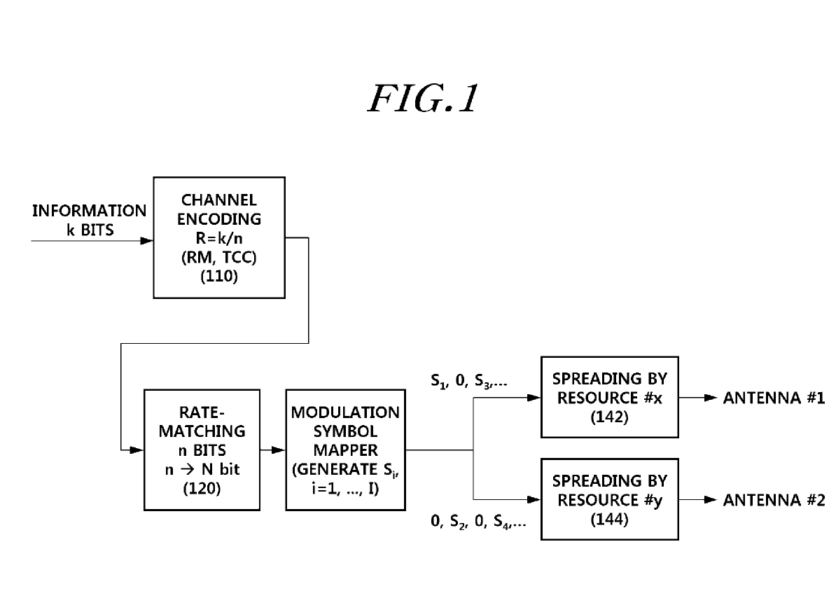

FIG. 1 illustrates a process of generating signals as shown in Table 1. A channel encoder 110 generates (encodes) information bits (k bits) having a length of k as (into) code bits of n bits. N bits are generated by performing RM (Rate Matching) of the n bits like the element designated by reference numeral 120, modulation symbols S1, S2, . . . , SI are generated based on the generated N bits like the element designated by reference numeral 130. In LTE, modulation symbols of the PUCCH are spread by a cyclic shift sequence over twelve subcarriers, and distinguished for each user. In LTE-A, an increase in an amount of information bits allocated to the PUCCH is considered by allocating two or more sequences for each user, one sequence being allocated for each user in LTE. A signal configuration considering a transmission antenna and a spreading resource is represented as shown in Table 1.

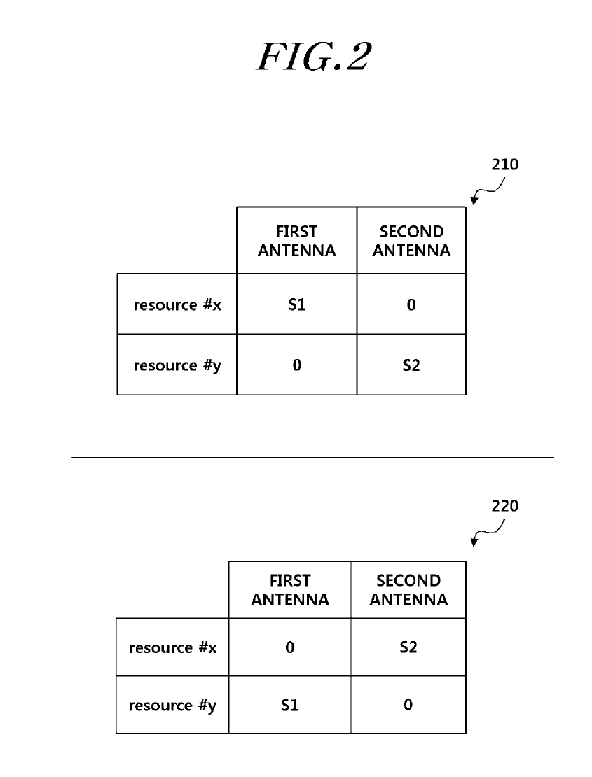

FIG. 2 illustrates a configuration of a signal using two antennas according to an embodiment of the present invention. In FIG. 2, each antenna distinguishes signals through different resources and simultaneously can transmit one bit which is new information. Accordingly, both antennas transmit signals generated as resources having orthogonality and can analyze information by considering the two signals and resources transmitting a signal.

When two antennas and two resources are used in FIG. 2, the number of cases corresponds to two. The two cases include a first case 210 where a first antenna codes a symbol by using resource #x and a second antenna codes a symbol by using resource #y and a second case 220 corresponding to an inverse of the first case. As a result, a reception side combines two information pieces according to the first case and the second case and information generated by combining S1 and S2, so that information more than information transmitted through actual symbols can be obtained. In the cases 210 and 220, the information more than information transmitted through the actual symbols refers to information which is additionally transmitted by resource-antenna mapping, that is, a further one bit other than bits transmitted through the actual symbols.

The antenna in an embodiment of the present invention includes a physical or a logical antenna.

The SORM scheme of FIG. 1 provides a signal configuration in which two antenna do not simultaneously transmit a signal. However, a signal configuration of FIG. 2 which is included in an embodiment of the present invention can be extended to two types since the reception side can distinguish the cases 210 and 220. Accordingly, it is possible to transmit an additional code bit of one bit in every transmission section of each channel symbol. Such an additional bit transmission has an effect of improving the capability of the code by reducing puncturing numbers of a rate-matching algorithm.

An extended SORM scheme from the SORM scheme of FIG. 1 can be used as a channel symbol allocation scheme in which a resource and an antenna are selected according to an input bit and a modulation symbol is mapped by considering an increase in the additional bit.

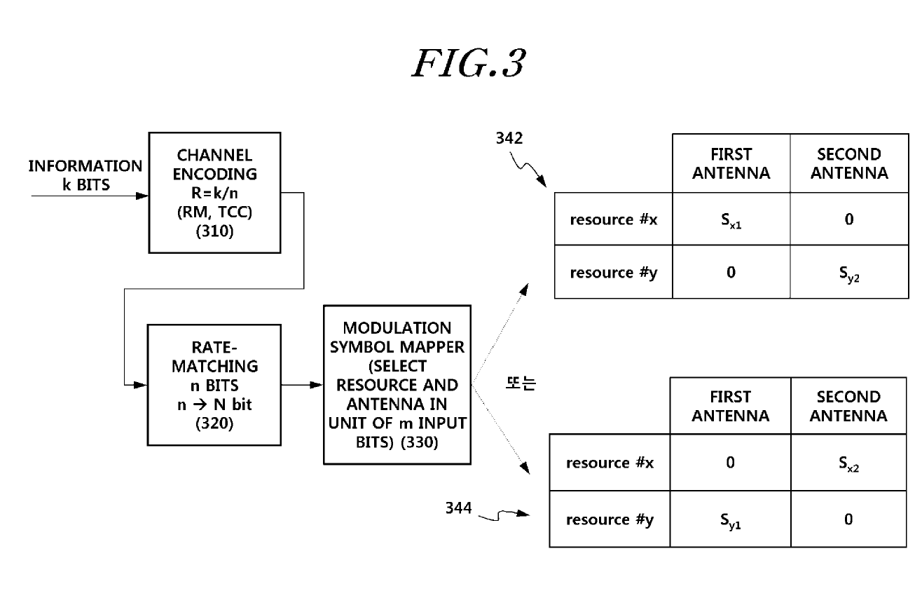

FIG. 3 illustrates a process of allocating signals according to an embodiment of the present invention. In FIG. 3, k bits of information to be transmitted are encoded into n bits via a channel encoding 310. A control information channel transmitted through an uplink according to an embodiment of the present invention is a PUCCH, and the PUCCH 2/2a/2b type can be used as described above. In FIG. 3, k bits (values of k may be 14 to 26) of information are generated (converted or encoded) as (into) code bits of n bits via the channel encoding 310. An embodiment of the channel encoding 310 may include an extended encoding of (20, A) code based on a Reed Muller code or a combination of the two. Further, another embodiment of the channel encoding includes TCC (Tail-biting Convolutional Code). In this case, an encoding rate in TCC can be 1/3 (=k/n). The n bits which are the code bits become N (=40) bits via a rate-matching matching process 320. At this time, N may be a number of fixed bits. In this case, a rate-matching algorithm fits n code bits (n bits) output from a channel encoder to N through puncturing or repetition. When k, which is the number of pieces of information, is a value equal to or larger than 14, the code bits of 40 bits are achieved through the puncturing. More specifically, N bits are mapped into modulation symbols to generate the modulation symbols, and a modulation scheme is determined by a modulation order of the modulation symbol.

In the rate-matching algorithm, resources and antennas are selected in the unit of m bits of output code bits according to a prearranged mapping rule and modulation symbols are determined, and thus the extended SORM scheme as shown in FIG. 3 can be configured. Here, a value of m may have a value larger than a modulation order mapped into the modulation symbol by 1 in the conventional SORM scheme since it corresponds to a scheme of further transmitting one bit information due to difference (discrimination) between elements designated by reference numerals 342 and 344 when there are two antennas.

In an embodiment of the present invention, if k=14 to 26 and k/n=1/3, N may have a value of 30, 40, or 50. Further, since the PUCCH of LTE Rel. 8 is mapped into ten modulation symbols, an extended signal set for each value of m can be configured considering a case of m=3, 4, and 5. Based on an available modulation order according to the value of m, BPSK and QPSK can be used for the case of m=3, 4, and 5.

A configuration of FIG. 3 according to an embodiment of the present invention includes the channel encoder 310 for converting k bits of information to be transmitted to n bits in order to transmit predetermined control information in a control channel, a modulation symbol mapper 330 for selecting m bits from the n bits and generating T modulation symbols in T transmission antennas in order to transmit (m−d) bits among the m bits, and a transmitter (first antenna, second antenna) for transmitting the modulation symbol generated through the T transmission antennas to a channel symbol, wherein d bits which are not included in the modulation symbol generation corresponds to information distinguishable by resources used for generating the modulation symbols in the T antennas. Of course, the m bits can be selected from N bits by rate-matching n bits to the N bits.

When T is 2 as shown in FIG. 3, transmission antennas include a first antenna and a second antenna, the modulation symbol mapper generates a modulation symbol to be transmitted through the first antenna using a first resource, and generates a modulation symbol to be transmitted through the second antenna using a second resource. Here, the first resource and the second resource have orthogonality. In this process, when the modulation symbol is overlappingly transmitted, two antennas of four antennas can transmit a symbol modulated by using the same resource.

Here, d, which is the difference between (m−d) bits and m bits, is equal to or smaller than log 2(T!) because a number of cases by which a corresponding antenna can modulate a channel by using different resources is T! when T corresponding to a number of antennas is increased and a bit which can be indicated through the value is an integer equal to or smaller than log 2(T!).

When there are two antennas, the channel encoder, the modulation symbol mapper, and the transmitter may be configured as follows. In order to transmit control information through the control channel, the channel encoder converts k bits of information desired to be transmitted to n bits corresponding to the code bits to be transmitted. Further, the modulation symbol mapper selects m bits from the n bits, generates a first modulation symbol to transmit (m−1) bits of the m bits by selecting one of the first resource and the second resource, and generates a second modulation symbol by using a resource which has not been selected in a process of generating the first modulation symbol. Of course, the m bits can be selected from N bits by rate-matching the n bits to the N bits. Further, the transmitter can transmit the first modulation symbol through the first transmission antenna and transmit the second modulation symbol through the second transmission antenna. The first resource and the second resource may be configured to have the orthogonality so that the reception side can distinguish channel symbols transmitted through the two antennas. When there are four antennas and the same channel symbol is overlappingly transmitted, the modulation symbol can be transmitted using the same resource through two antennas. Of course, according to a communication condition, the modulation symbol can be transmitted using the same resource through three antennas, and the modulation symbol can be transmitted using a different resource through the remaining one antenna.

Hereinafter, a process of simultaneously transmitting signals through a plurality of antennas according to an embodiment of the present invention when there are two, three, and four antennas will be described.

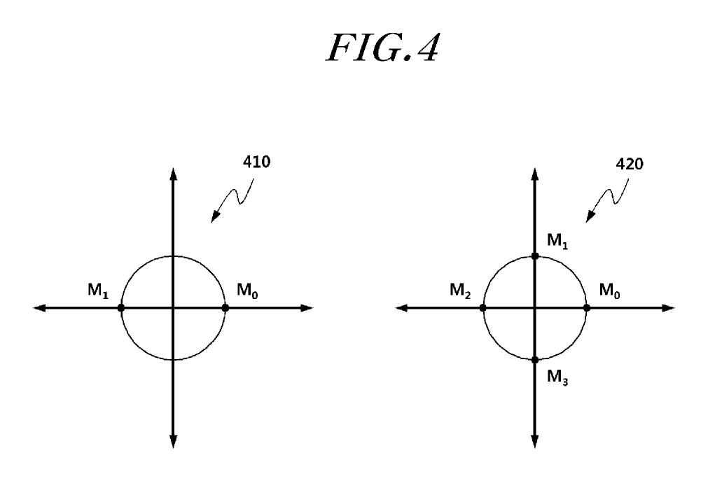

FIG. 4 illustrates a modulation scheme according to an embodiment of the present invention. The extended SORM scheme can be applied to a configuration of a constellation in which a predetermined phase is shifted such as each modulation scheme, that is, BPSK (Binary Phase-Shift Keying) 410 and QPSK (Quadrature Phase-Shift Keying) 420. Besides, various modulations such as 16QAM (Quadrature Amplitude Modulation), 64QAM, etc. can be used, but the present invention is not limited by such a modulation scheme.

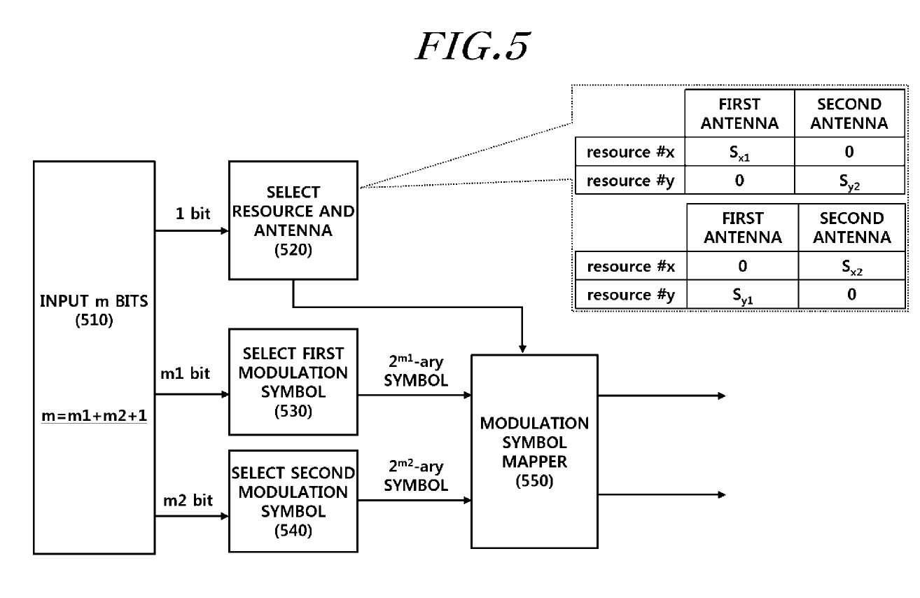

FIG. 5 illustrates a process of generating modulation symbols according to an embodiment of the present invention. The channel input mapper 330 of FIG. 3 selects matching between resources and antennas by using a specific bit. When m bits are input in step designated by reference numeral 510, the m bits are divided into m1 bits, m2 bits, and one bit. The one bit is used to select the resource and the antenna like the step designated by reference numeral 520. The resource refers to a spread resource for the modulation symbol. There are two cases depending on resources and antennas, the two cases corresponding to the elements designated by reference numerals 342 and 344 described in FIG. 3.

That is, the antenna and the resource for the modulation of m1 and m2 are selected in the step designated by reference numeral 520. When the selected value is input to a modulation symbol mapper 550, the first antenna and the second antenna modulate m1 bits and m2 bits to generate symbols, respectively, and transmit the generated symbols. As a result, actually transmitted information corresponds to symbols for m1 and m2, but there is an effect of transmitting information of m (m=m1+m2+1) bits desired to be transmitted since the reception side can infer selection information between antennas and resources and an effect of having the high signal transmission efficiency. In other words, although energy for transmission of one bit other than the m1 bits and m2 bits among the m bits is not consumed, the information for the m bits is transmitted. That is, even if information of the one bit is not included in the symbol, the reception side can identify the one bit according to the symbol allocation of the antenna, so that an effect of transmitting the information is obtained while not changing the energy or not consuming the energy for the transmission of a separate one bit. In the transmission of the symbol, multidimensional transmission may include new information and the reception side has an effect of receiving the information. Accordingly, although a total of m bits are transmitted, only the m1 bits and the m2 bits are mapped into symbols of antennas. In FIG. 5, mapping of resources and antennas can be selected using a specific bit (e.g. a first bit). That is, the specific bit corresponds to mapping information and thus the reception side can recognize a value of the corresponding bit. However, it is merely an embodiment of the present invention, and the determination can be achieved through a whole configuration as well as the specific bit.

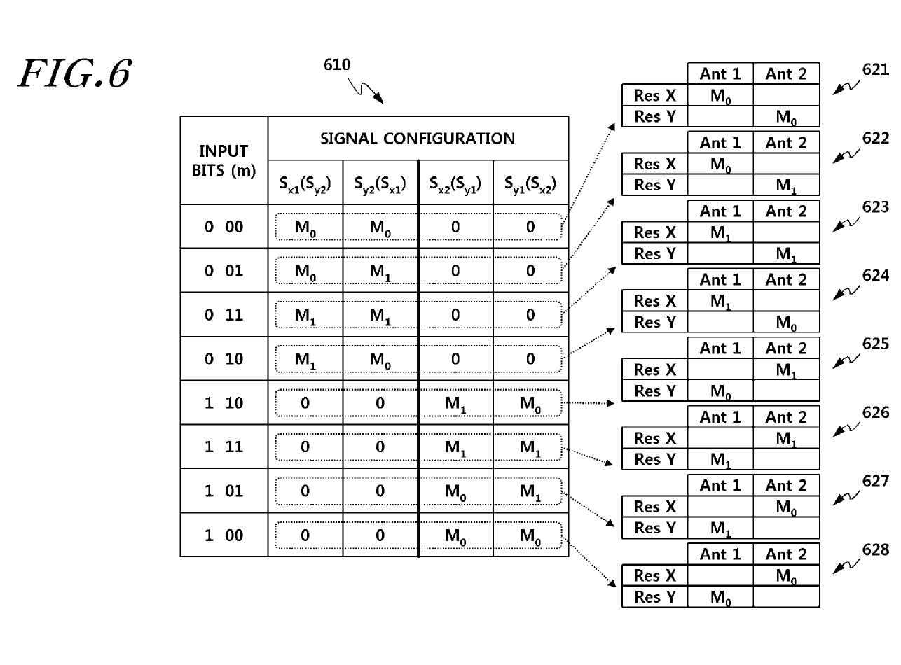

FIG. 6 illustrates an example showing a configuration of a signal transmitted when m is 3, two antennas are used, and each of the antennas uses the BPSK modulation scheme according to an embodiment of the present invention. As shown in FIG. 5, when m is 3 and two antennas are used, information only for two bits is transmitted since the reception side can analyze one bit according to a selection scheme of antennas and resourced. Further, an example of a configuration of a modulation symbol allocated for each antenna and each resource is illustrated. The embodiment of FIG. 6 implements the signal configuration such that a bit error caused by a symbol error is minimized based on Gray mapping.

In FIG. 6, the element designated by reference numeral 610 is an example of configuring a signal for each input bit. A resource and an antenna are matched by a first bit of the input bits of three bits (m=3). When the first bit is 0, a first antenna generates a modulation symbol by using a resource x and a second antenna generates a modulation symbol by using a resource y as illustrated in the elements designated by reference numerals 621, 622, 623, and 624. When the first bit is 1, the first antenna generates the modulation symbol by using the resource y and the second antenna generates the modulation symbol by using the resource x as illustrated in the elements designated by reference numerals 625, 626, 627, and 628. For the remaining two bits, the two antennas modulate information of one bit (m1=1, m2=1) by using BPSK modulation schemes M₀ and M₁, respectively and allocate M₀ and M₁. Accordingly, actually transmitted information is two bits (M₀, M₁), but it is derived from the matching of resources and antennas that information of the one bit is transmitted.

In FIGS. 5 and 6, the reception side can analyze m bits based on symbols within resources and entire areas to which the symbols are mapped.

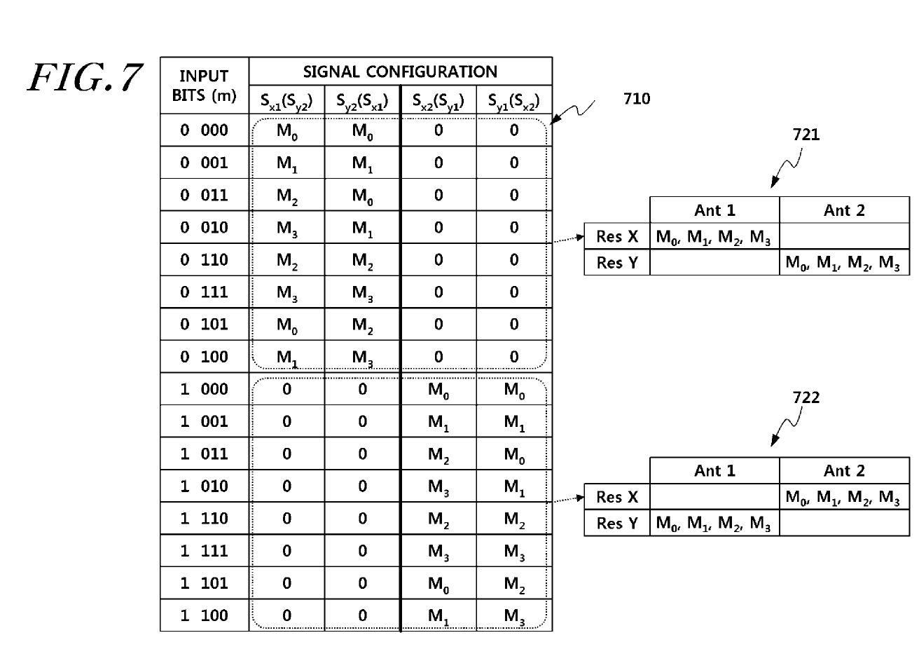

FIG. 7 illustrates a signal configuration scheme according to another embodiment of the present invention. In FIG. 7, m is four bits. Since there are two antennas, the discrimination can be achieved using one bit as described above. FIG. 7 uses the first bit for the discrimination like FIG. 6. Information for the remaining three bits can be provided through the modulation, wherein the modulation can be performed by dividing the three bits into one bit (BPSK), and two bits (QPSK). A QPSK symbol is generated for each of two bits, and information can be configured by combining the bits. Here, the symbol and the information can be matched by separating the BPSK and the QPSK for the one bit and the two bits, but the symbol and the information can be matched based on the entire bits. In FIG. 7, both of two antennas generate information of three bits by using the QPSK, and a scheme of transmitting first one bit according to selection information of antennas and resources is illustrated. In other words, among transmitted information of four bits, three bits indicate a part (symbol) carrying actual energy. However, there is an effect of transmitting information of four bits since a position carrying the energy is included.

In FIG. 7, the element designated by reference numeral 710 corresponds to an example of configuring a signal for each input bit. An antenna and a resource are matched by using a first bit of the input bits of four bits (m=4). When the first bit is 0, the first antenna generates a modulation symbol by using a resource x, and the second antenna generates a modulation symbol by using a resource y in a scheme designated by reference numeral 721. When the first bit is 1, the first antenna generates the modulation symbol by using the resource y, and the second antenna generates the modulation symbol by using the resource x in a scheme designated by reference numeral 722. In the schemes designated by reference numerals 711 and 722, each antenna selects a particular symbol from M₀, M₁, M₂, and M₃, and the selection is configured as shown in the element designated by reference numeral 710.

For the remaining three bits, M₀, M₁, M₂, and M₃are allocated to indicate the three bits by modulating each of two bit information (m1=2, m2=2) by using the QPSK modulation scheme (M₀, M₁, M₂, and M₃). Of course, it is possible to configure such that m1 becomes one bit and m2 becomes two bits through demodulation using the BPSK scheme by the first antenna and demodulation using the QPSK scheme by the second antenna, and they may be variously applied to the present invention.

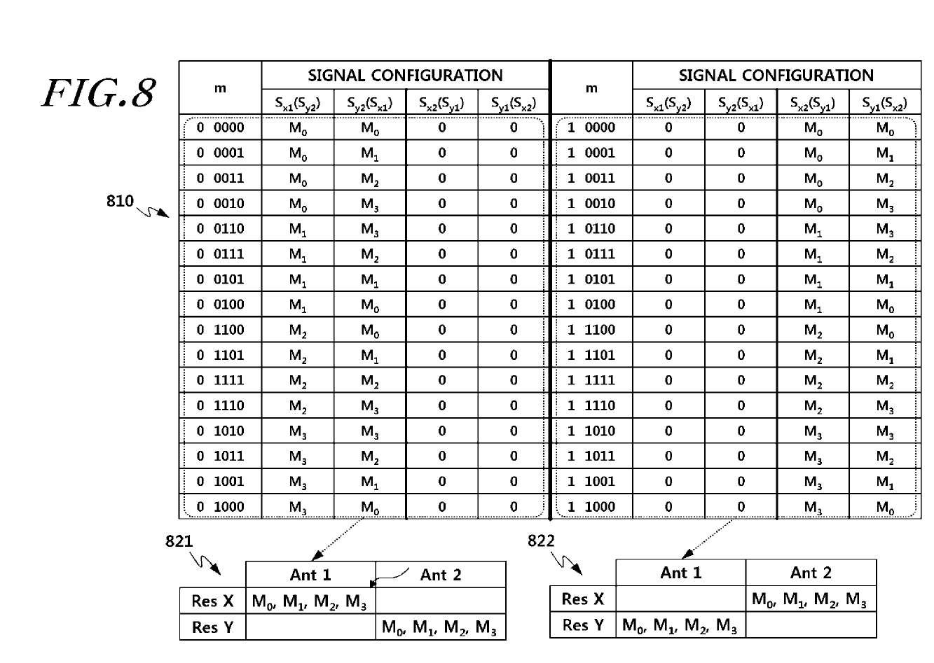

FIG. 8 illustrates a signal configuration scheme according to yet another embodiment of the present invention. In FIG. 8, m is five bits.

FIG. 8 shows a signal configuration in which a first bit is used in the selection of resources and antennas and the remaining four bits are modulated in the same way as that of FIGS. 6 and 7 when m is 5 according to an implementation manner of FIG. 5. The element designated by reference numeral 810 corresponds to an example of configuring a signal for each input bit. A resource and an antenna are matched by a first bit of the input bits of five bits (m=5). When the first bit is 0, the first antenna generates a modulation symbol by using a resource x and the second antenna generates a modulation symbol by using a resource y in a scheme designated by reference numeral 821. When the first bit is 1, the first antenna generates the modulation symbol by using the resource y and the second antenna generates the modulation symbol by using the resource x in a scheme designated by reference numeral 822. In the schemes 811 and 822, each antenna selects a particular symbol from M₀, M₁, M₂, and M₃, and the selection is configured as shown in the element designated by reference numeral 810.

For the remaining four bits, M₀, M₁, M₂, and M₃are allocated to indicate the four bits by modulating each two bit information (m1=2, m2=2) by using the QPSK modulation scheme (M₀, M₁, M₂, and M₃).

In FIGS. 7 and 8 also, the reception side can analyze m bits based on symbols within resources and entire areas to which the symbols are mapped.

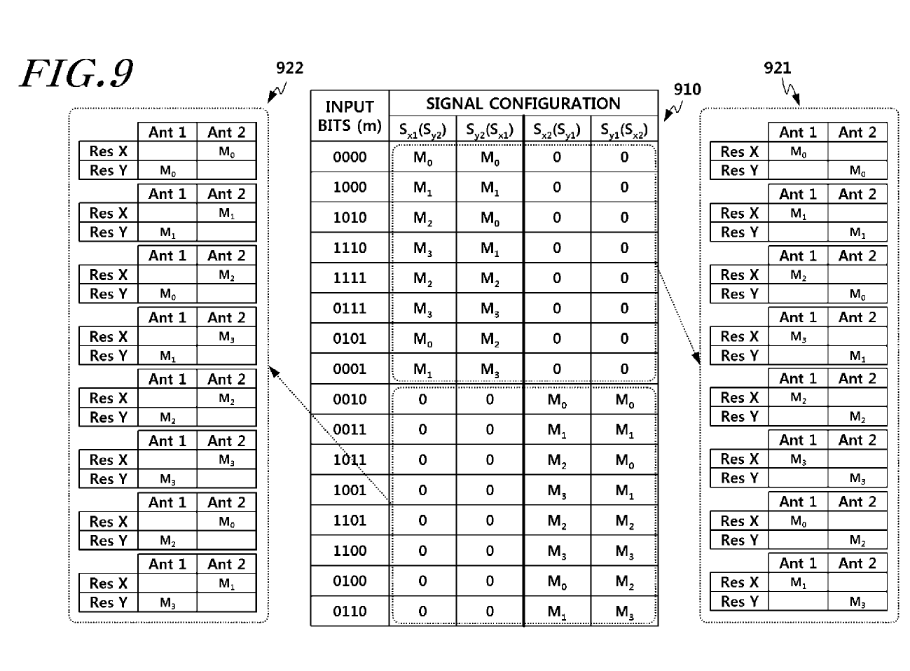

FIG. 9 illustrates a signal configuration scheme according to still another embodiment of the present invention. In FIG. 9, m is four bits and another example of Gray mapping is illustrated. In a modulation scheme of FIG. 9, four bits are modulated as shown in FIG. 7, but the matching of antennas and resources is not achieved through the specific bit. In schemes used in FIGS. 6, 7, 8, one bit information indicating the selection of the antenna and the resource is distinguished in a predetermined bit position like the configuration of FIG. 5. However, FIG. 9 can configure whole mapping bits instead of the specific bit in the mapping process. As described above, a modulation symbol allocation scheme can be variously constructed in the extended SROM scheme. Accordingly, when a modulation symbol is transmitted according to the signal configuration as shown in the element designated by reference numeral 910, the reception side can reconstruct information of four bits by using spread resource information (x or y) for the modulation symbol transmitted from the first antenna and spread resource information (x or y) for the modulation symbol transmitted from the second antenna which are mapping information. In other words, multidimensional transmission is possible in the symbol transmission according to the embodiment of the present invention, and the multidimensional transmission may include the matching of symbols and resources and new information between resource information. As a result, the reception side has an effect of receiving the information.

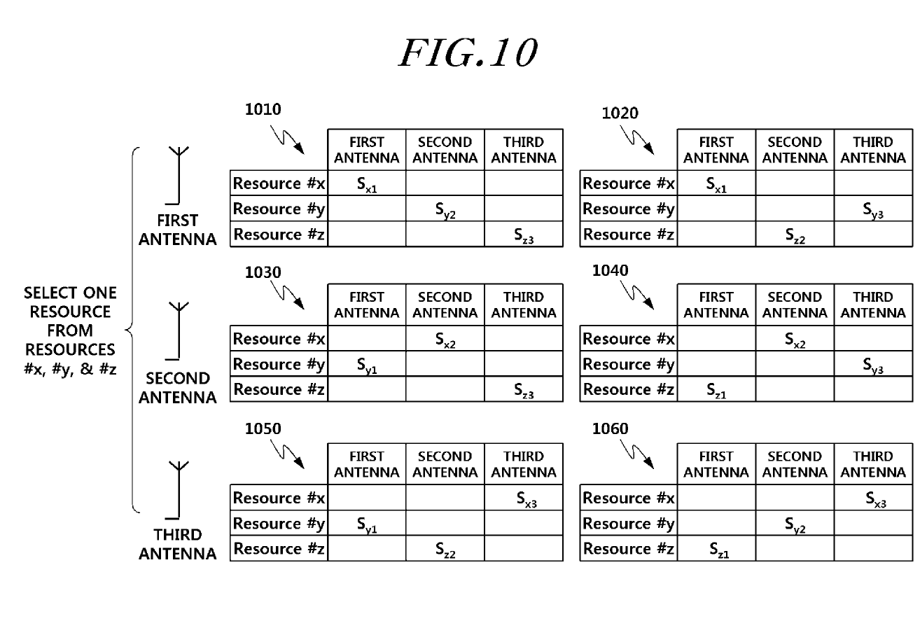

FIG. 10 illustrates a configuration of a signal when there are three antennas according to an embodiment of the present invention. When there are N antennas and each antenna desires spreading by using a different resource, there may be N! schemes. In the above description, when two antennas generate modulation symbols by using two spreading resources, two cases corresponding to 2! cases are generated and information of one bit is included using the difference. Accordingly, when three antennas are used, there may be six cases corresponding to 3! cases (1010, 1020, 1030, 1040, 1050, and 1060). The six cases can be expressed by three bits or two bits. However, since 6 is not included in powers of 2, the six cases are insufficient for the expression by three bits (three bits correspond to a total of eight cases). Accordingly, the matching between antennas and resources can be used in expressing the two bits. In the embodiment of FIG. 10, m bits are transmitted including all parts in which each antenna transmits the symbol through the matching between resources and antennas.

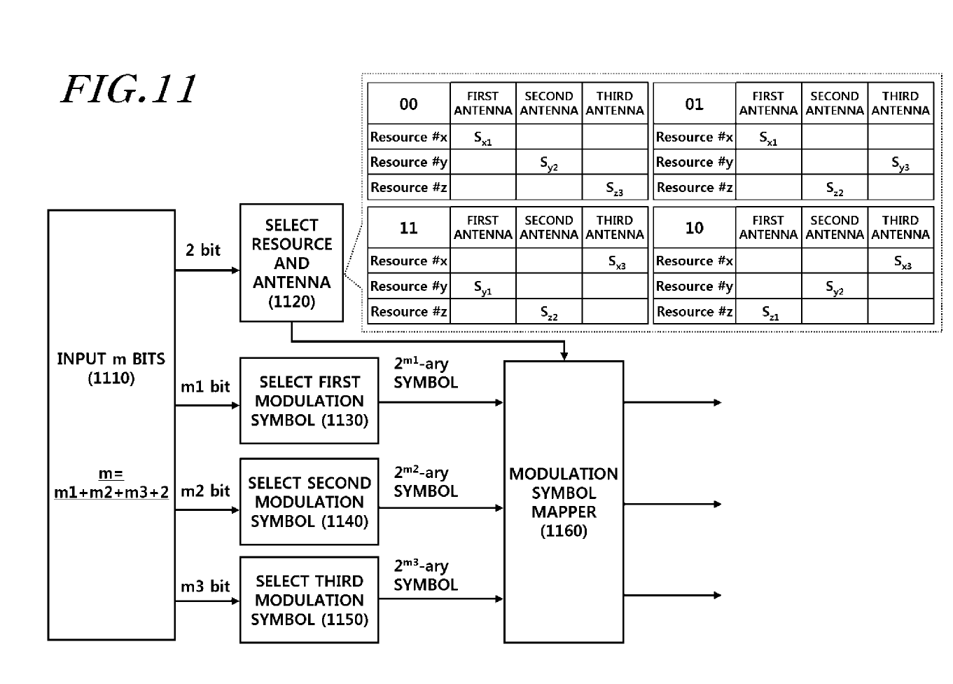

FIG. 11 illustrates a configuration in which there are three antennas and a modulation symbol is generated such that the matching between resources and antennas is selected through a bit in a particular position according to an embodiment of the present invention. As shown in FIG. 10, four antenna-resource matchings are selected from six antenna-resource matchings such that information of two bits can be expressed according to the antenna configuration. According to an embodiment of the present invention, the elements designated by reference numerals by 1010, 1020, 1050, and 1060 of FIG. 10 are selected.

FIG. 11 has the same construction as that of FIG. 5, but there are differences in that information of two bits is input in a process of selecting the resource and the antenna and three modulation symbols are generated. Information modulated by three antennas corresponds to the m1 bits, the m2 bits, and m3 bits, respectively, and m=m1+m2+m3+2.

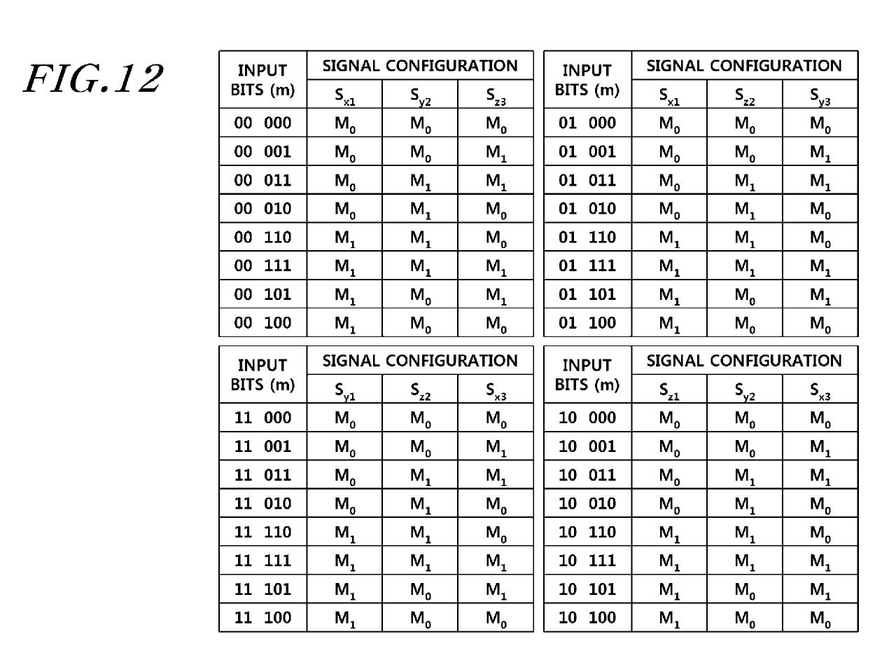

FIG. 12 illustrates a configuration of a signal when there are three antennas according to an embodiment of the present invention. As shown in FIG. 10, four antenna-resource matching are selected from six antenna-resource matchings such that information of two bits can be expressed according to the antenna configuration. According to an embodiment of the present invention, the elements designated by reference numerals by 1010, 1020, 1050, and 1060 of FIG. 10 are selected.

When m is 5, since two bits can be distinguished by the antenna configuration, transmission can be achieved through first, second, and third antennas by modulating the remaining three bits, one at a time. FIG. 12 shows a case where the BPSK scheme is applied for one bit.

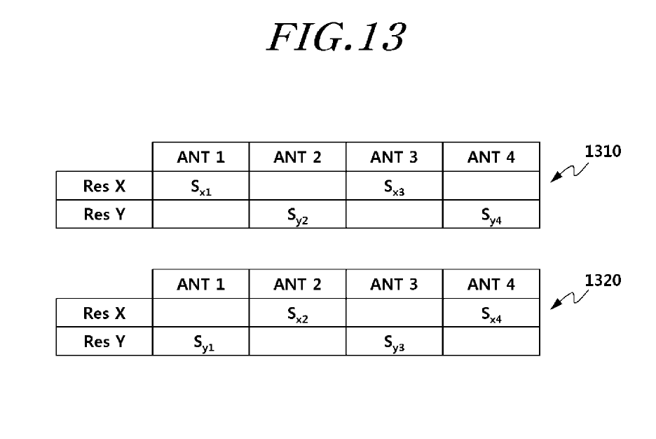

FIG. 13 illustrates an example in which multiple antennas overlappingly transmit signals according to an embodiment of the present invention.

In FIG. 13, two antennas of four antennas perform spreading by using the same resource. Accordingly, an implementation of FIG. 13 is equal to the case of two antennas as described above. The element designated by reference numeral 1310 of FIG. 13 corresponds to an overlapping configuration designated by reference numeral 342 of FIG. 3. Therefore, according to such a configuration, the antenna and the resource can be matched by using one bit.

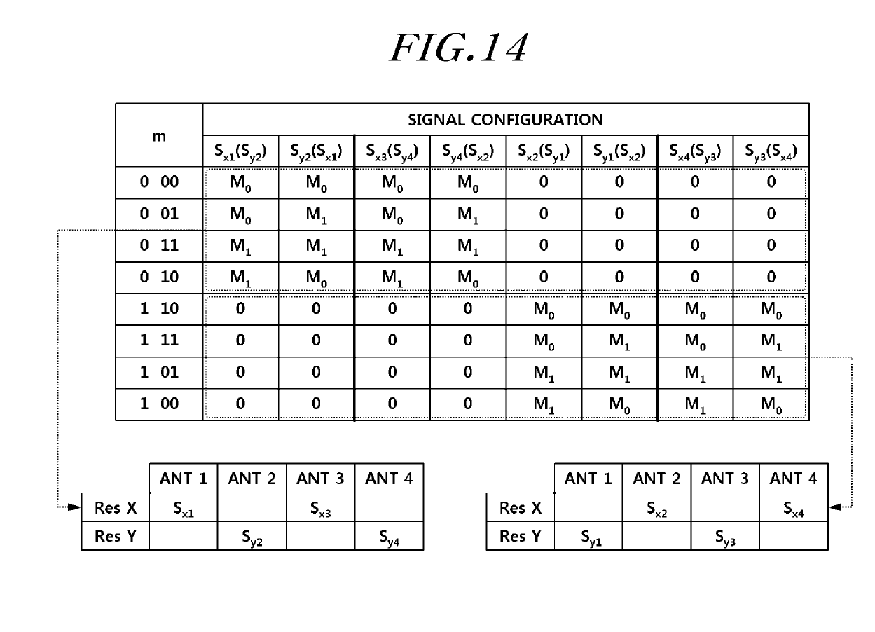

FIG. 14 illustrates an example in which a signal is configured such that multiple antennas can overlappingly transmit symbols according to an embodiment of the present invention. A configuration of FIG. 14 is implemented such that the signal configuration of FIG. 6 can be overlappingly transmitted.

In the signal configuration described above, since the matching between the particular antenna and the particular resource may vary depending on the implementation, the present invention is not limited to one-to-one matching between antennas and resources. In FIG. 14, a one-to-many relation (two antennas include symbols in one resource) between antennas and resources is illustrated.

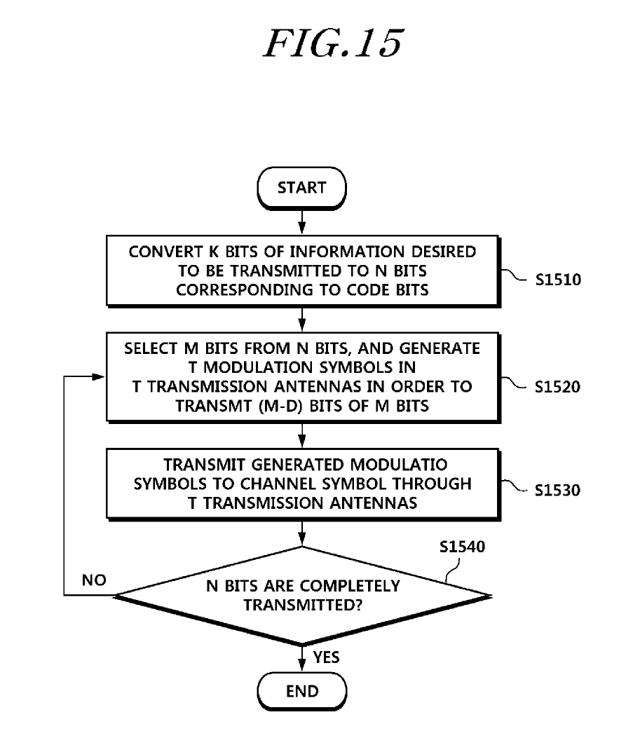

FIG. 15 illustrates a process of configuring a control channel by using uplink diversity according to an embodiment of the present invention.

In order to transmit predetermined control information through the control channel, k bits of the information desired to be transmitted are converted to n bits corresponding to the code bits in step S1510. Further, m bits are selected from the n bits and T transmission antennas generate T modulation symbols in order to transmit (m−d) bits of the m bits in step S1520. The generated modulation symbols are transmitted through the T transmission antennas in step S1530. At this time, d bits which have not been included in the modulation symbol generation among the m bits corresponds to information distinguishable by the resources used for generating the modulation symbols in the T antennas. The information has been described in the example of expressing the information of one bit or more in the scheme of matching antennas and resources. After transmission is completed, it is identified whether n bits which should be transmitted are completely transmitted in step S1540. When the n bits are not completely transmitted, step S1520 is performed to transmit the following m bits. When the n bits are completely transmitted, the process is terminated.

When T is 2, that is, when the number of transmission antennas is 2, the two antennas are distinguished using two resources and symbols for (m−1) bits of m bits to be transmitted are modulated and modulation symbols can be generated as shown in FIGS. 6, 7, 8, and 9. That is, when the transmission antennas include the first antenna and the second antenna, a modulation symbol to be transmitted through the first antenna is generated using the first resource and a modulation symbol to be transmitted through the second antenna is generated using the second resource in step S1520. The first resource and the second resource have the orthogonality.

Meanwhile, when there are four antennas, that is, when T is 4 and transmission antennas include first, second, third, and four antennas, modulation symbols transmitted through the first and second antennas are generated using the first resource and modulation symbols transmitted through the third and fourth antennas are generated using the second resource so that overlapping modulation symbols are generated in step S1520. Of course, the first resource and the second resource have the orthogonality.

An actual modulation symbol transmits information of (m−d) bits having a size smaller than a size of information of m bits desired to be transmitted. Here, omitted information is information which can be transferred by the antenna-resource matching, and d may be an integer equal to or smaller than log 2(T!).

Meanwhile, step S1510 may include a process of converting k bits to n bits via the channel encoding. As described above, Reed-Muller encoding or TCC encoding are performed and then rate matching can be performed. In other words, m bits can be selected from N bits by rate matching the n bits to N bits.

Referring to a process of transmitting information by using two antennas, in order to transmit predetermined control information in the control channel, k bits of the information desired to be transmitted are converted to n bits corresponding to the code bits, and the n bits are selected from m bits. Further, in order to transmit (m−1) bits of the m bits, one of the first resource and the second resource is selected so that the first modulation symbol can be generated. After the second modulation symbol is generated using a resource which has not been selected in the (b) step, the first modulation symbol is transmitted through the first transmission antenna and the second modulation symbol is transmitted through the second transmission antenna. Further, the first resource and the second resource have the orthogonality.

When four antennas are used, the first modulation symbol is transmitted through the first transmission antenna and the second transmission antenna, and the second modulation symbol is transmitted through the third transmission antenna and the fourth transmission antenna.

The control channel of FIG. 15 may be the PUCCH, and the control information may be one of CPI, PMI, RI, ACK, and NAK.

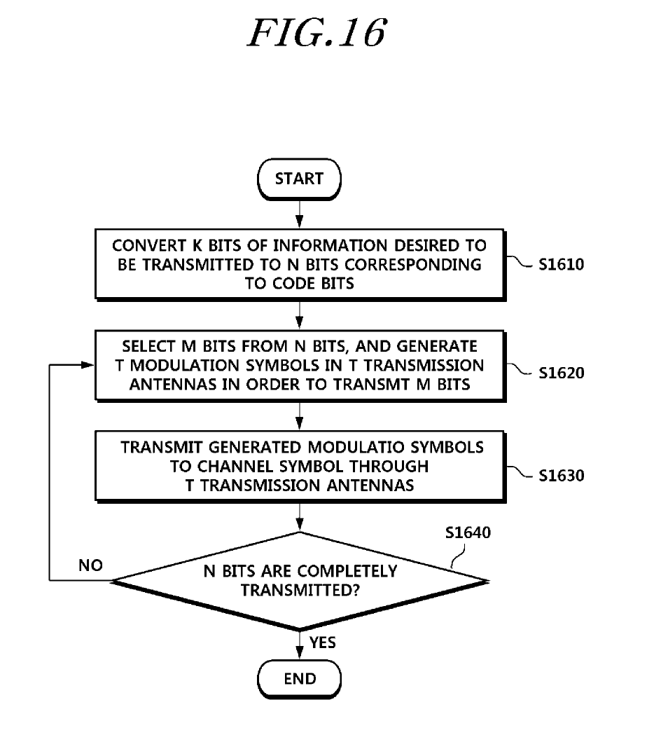

FIG. 16 illustrates a process of configuring a control channel by using uplink diversity according to another embodiment of the present invention.

FIG. 16 shows a process including all of the bit allocation of FIG. 15 and the bit allocation of FIG. 9.

In order to transmit the predetermined control information through the control channel, k bits of the information desired to be transmitted are converted to n bits which are the code bits in step S1610. Further, m bits are selected from the n bits, and T modulation symbols are generated in T transmission antennas in order to transmit the information of m bits in step S1620.

The modulation symbols generated in step S1620 are transmitted through the T transmission antennas in step S1630.

At this time, the modulation symbols generated in the T transmission antennas and for generating the modulation symbols in the T antennas, the T transmission antennas generate the T modulation symbols by using R different resources. After transmission is completed, it is identified whether n bits which should be transmitted are completely transmitted in step S1640. When the n bits are not completely transmitted, step S1720 is performed to transmit the following m bits. When the n bits are completely transmitted, the process is terminated.

R may be equal to or larger than T/2. Further, information of m bits can be expressed through the T modulation symbols and mapping information on the R resources used by the T antennas. The mapping information refers to mapping information on a resource used by the antenna as described above. A combination of the mapping information and the modulation symbol generated by each antenna may configure the signal by using the channel symbol as shown in FIGS. 6, 7, 8, and 9.

According to another embodiment of the present invention, the number of information distinguishable by the modulation symbols generated by the T transmission antennas and the resources used for generating the modulation symbols by the T antennas is equal to or larger than 2 m, which includes the part indicating information through the combination of the scheme of matching antennas and resources and modulation symbols. After transmission is completed, it is identified whether n bits which should be transmitted are completely transmitted in step S1640. When the n bits are not completely transmitted, step S1620 is performed to transmit the following m bits. When the n bits are completely transmitted, the process is terminated.

A demodulation process in a reception end of an uplink diversity signal transmitted by an uplink is as follows.

The uplink diversity signal received by a plurality of reception antennas at a base station according to an embodiment of the present invention is de-spread by a cyclic shift sequence allocated for each reception antenna. The de-spread signal has a channel value for each resource, and Euclidean distances of respective elements of a channel symbol set from the reception antenna is calculated in connection with a channel coefficient value estimated by a reference signal. Each Euclidean distance can be calculated by Euclidean summation of each element and the reception antenna. Then, the Euclidean distances are compared with each other, and a signal (element) having the smallest Euclidean distance is selected and is input to a channel decoder. The channel encoder decodes information bit blocks (or payloads) corresponding to a multiple of a size of a used resource rather than performing a conventional decoding using a single resource.

The embodiments of the present invention described above have described mainly the uplink control channel, but it will be apparent to those skilled in the art that the embodiments also can be applied to a downlink control channel, a downlink data channel, an uplink data channel.

While the present invention has been shown and described with reference to certain exemplary embodiments and drawings thereof, it will be understood by those skilled in the art that various changes in form and details may be made therein without departing from the spirit and scope of the invention as defined by the appended claims. Accordingly, embodiments disclosed in the present invention are not to limit, but to describe the technical idea of the present invention, and the scope of the technical idea of the present invention is not restricted by the embodiments. Thus, as long as modifications fall within the scope of the appended claims and their equivalents, they should not be misconstrued as a departure from the scope of the invention itself.

1. A method for configuring a channel by using diversity, the method comprising:
converting k bits of information desired to be transmitted through a channel to n bits corresponding to code bits;
selecting m bits from the n bits and generating T modulation symbols by T transmission antennas to transmit the m bits; and
transmitting the T modulation symbols to a channel symbol by the T transmission antennas,
wherein in generating of the T modulation symbols, the T transmission antennas generate the T modulation symbols by using R different resources.

2. The method as claimed in claim 1, wherein R is equal to or larger than T/2.

3. The method as claimed in claim 1, wherein the m bits can be indicated by the T modulation symbols and mapping information on the R resources used by the T transmission antennas.

4. The method as claimed in claim 1, wherein the T transmission symbols generated by the T transmission antennas are for distinguishing (m−d) bits of the m bits, and d bits are information distinguishable by resources used for generating the modulation symbols by the T transmission antennas.

5. The method as claimed in claim 4, wherein d is equal to or smaller than log 2(R!).

6. The method as claimed in claim 1, wherein, when T and R are 2 and transmission antennas include a first antenna and a second antenna, generating of the T modulation symbols comprises:
generating a modulation symbol to be transmitted through the first antenna by using a first resource; and
generating a modulation symbol to be transmitted through the second antenna by using a second resource,
wherein the first resource and the second resource have orthogonality.

7. The method as claimed in claim 1, wherein the channel is a PUCCH, and the information is one of CPI, PMI, RI, ACK, and NCK.

8. A method for configuring a channel by using diversity, the method comprising:
converting k bits of information to be transmitted through a channel to n bits corresponding to code bits;
selecting m bits from the n bits, and generating a first modulation symbol to transmit the m bits by selecting one of a first resource and a second resource which are different from each other;
generating a second modulation symbol by using a resource which has not been selected in generating of the first modulation symbol; and
transmitting the first modulation symbol through a first transmission antenna, and transmitting the second modulation symbol through a second transmission antenna,
wherein the m bit can be indicated by the modulation symbols generated by two transmission antennas and mapping information on the resources used for generating the modulation symbols by the two antennas.

9. The method as claimed in claim 8, wherein two modulation symbols generated by the two antennas are for distinguishing (m−1) bits of the m bits, and 1 bit is information distinguishable by resources used for generating the modulation symbols by the two antennas.

10. An apparatus to configure a channel by using diversity, the apparatus comprising:
a channel encoder for converting k bits of information to be transmitted through a channel to n bits corresponding to code bits;
a modulation symbol mapper for selecting m bits from the n bits and generating T modulation symbols in T transmission antennas to transmit the m bits; and
a transmitter for transmitting the T modulation symbols as channel symbols from the T transmission antennas,
wherein the modulation symbol mapper generates the T modulation symbols by using R different resource in the T transmission antennas.

11. The apparatus as claimed in claim 10, wherein R is equal to or larger than T/2.

12. The apparatus as claimed in claim 10, wherein the m bits are indicated by the T modulation symbols and mapping information indicating that the T transmission antennas use the R resources.

13. The apparatus as claimed in claim 10, wherein the T modulation symbols generated in the T antennas are for distinguishing (m−d) bits of the m bits, and d bits are information distinguishable by resources used for generating the modulation symbols in the T transmission antennas.

14. The apparatus as claimed in claim 13, wherein d is equal to or smaller than log 2(R!).

15. The apparatus as claimed in claim 10, wherein, when T and R are 2 and transmission antennas include a first antenna and a second antenna, the modulation symbol mapper generates a modulation symbol to be transmitted through the first antenna by using a first resource and generates a modulation symbol to be transmitted through the second antenna by using a second resource, wherein the first resource and the second resource have orthogonality.

16. The apparatus as claimed in claim 10, wherein the channel is a PUCCH and the information is one of CPI, PMI, RI, ACK, and NAK.

17. An apparatus to configure a channel by using diversity, the apparatus comprising:
a channel encoder for converting k bits of information to be transmitted through a channel to n bits corresponding to code bits;
a modulation symbol mapper for selecting m bits from the n bits, generating a first modulation symbol by selecting one of a first resource and a second resource which are different, and generating a second modulation symbol by using a resource which has not been selected in generating the first modulation symbol in order to transmit the m bits; and
a transmitter for transmitting the first modulation symbol through a first transmission antenna and transmitting the second symbol through a second transmission antenna,
wherein the m bits are expressed by the modulation symbols generated in the two transmission antennas and mapping information of resources used for generating the modulation symbols in the two antennas.

18. The apparatus as claimed in claim 17, wherein the two modulation symbols generated in the two antennas are for distinguishing (m−1) bits of the m bits, and 1 bit is information distinguishable by resources used for generating the modulation symbols in the two transmission antennas.

19. A method for configuring a channel by using diversity, the method comprising:
converting k bits of information to be transmitted through a channel to n bits corresponding to code bits and selecting m bits from the n bits;
generating T modulation symbols to be transmitted with second energy smaller than first energy consumed for completely transmitting the m bits; and
transmitting the T modulation symbols with the second energy by using T transmission antennas,
wherein, in generating of the T modulation symbols, the T transmission antennas generate the T modulation symbols by using R different resources.

20. The method as claimed in claim 19, wherein the second energy is energy consumed for generating (m−d) bits of the m bits, and d bits are information distinguishable by resources used for generating the modulation symbols in the T transmission antennas.

21. A method for receiving information by using diversity, the method comprising:
receiving T modulation symbols transmitted with second energy by T transmission antennas of a base station;
demodulating the received modulation symbols to generate information of m bits; and
decoding n bits including the m bits to generate information of k bits,
wherein the second energy is smaller than first energy consumed for completely transmitting the m bits.

22. The method as claimed in claim 21, wherein the second energy is energy consumed for transmitting (m−d) bits of the m bits, and d bits are information distinguishable by resources used for generating the modulation symbols in the T transmission antennas.

23. An apparatus to configure a channel by using diversity, the apparatus comprising:
a channel encoder for converting k bits of information to be transmitted through a channel to n bits corresponding to code bits;
a modulation symbol mapper for selecting m bits from the n bits, and generating T modulation symbols to be transmitted with second energy smaller than first energy consumed for completely transmitting the m bits; and
a transmitter for transmitting the T modulation symbols with the second energy by using T transmission antennas,
wherein the modulation symbol mapper generates the T modulation symbols by using R different resources in the T transmission antennas.

24. An apparatus to receive information by using diversity, the apparatus comprising:
a receiver for receiving T modulation symbols transmitted with second energy in T transmission antennas of a base station;
a demodulator for demodulating the received modulation symbols to generate information of m bits; and
a decoder for decoding n bits including the m bits to generate information of k bits,
wherein the second energy is smaller than first energy consumed for completely transmitting the m bits.
